(19) United States
(12) Patent Application Publication
(10) Pub. No.: US 2011/0022690 A1
(43) Pub. Date: Jan. 27, 2011

(54) COMMUNICATING DATA FROM A SOURCE DEVICE TO A TERMINAL

(75) Inventor: Christopher S. Del Sordo, Souderton, PA (US)

Correspondence Address: Motorola, Inc., 600 North US Highway 45, W4 - 39Q, Libertyville, IL, 60048-5343, US

(73) Assignee: General Instrument Corporation, Horsham, PA (US)

(21) Appl. No.: 12/508,699

(22) Filed: Jul. 24, 2009

(51) Int. Cl. G06F 15/177; G06F 15/16

(52) U.S. Cl. 709/221; 709/219

(57) ABSTRACT

In a method for receiving data from a source device in a terminal having a terminal identifier, a code section lookup table is received from the source device, in which the code section lookup table contains a correlation between terminal labels and specific code sections. In addition, a determination as to whether the terminal identifier of the terminal matches a terminal label listed in the code section lookup table is made, and if there is a match, the specific code section corresponding to the matching terminal label is identified and downloaded from the source device.

### BACKGROUND

Multi system operators (MSOs), such as, cable and satellite television programming providers, have provided services for many years to a number of customers through variously configured terminals. The terminals are often set top boxes configured to receive multimedia content, such as the television programming, from head ends of the MSOs. These terminals contain hardware platforms that vary significantly in hardware and/or software characteristics due to changes in the hardware platforms over the years. Consequently, there are many challenges for the MSOs when the hardware platforms are to be updated because a uniform set of code sections typically are not applicable to most of the terminals.

There are two conventional manners in which MSOs have updated the terminals. In one conventional manner, the MSOs have uploaded targeted code sections to the terminals based upon their respective hardware platforms in order to support hardware and software functioning in those terminals. Thus, in this conventional manner, the MSOs simultaneously communicate multiple ones of the targeted code sections to multiple terminals. In doing so, the MSOs are required to identify and track the hardware platforms of each of the terminals, which greatly increases the complexity of the systems employed by the MSOs. This problem is exacerbated as the number of terminals having different hardware platforms increases over time.

In another conventional manner, the MSOs have included the targeted code sections for each or a large number of different hardware platforms in a combined code section containing all of the targeted code sections and have communicated the combined code section to each of the terminals. Because the combined code section typically includes a large number of targeted code sections, the combined code section is often prohibitively large because of the large amount of bandwidth required to concurrently communicate the relatively large combined code section to multiple terminals.

### SUMMARY

Disclosed herein is a method for receiving data from a source device in a terminal having a terminal identifier. In the method, a code section lookup table is received from the source device, in which the code section lookup table contains a correlation between terminal labels and specific code sections. In addition, a determination of whether the terminal identifier of the terminal matches a terminal label listed in the code section lookup table is made, and if there is a match, the specific code section corresponding to the matching terminal label is identified and downloaded from the source device.

Also disclosed herein is a terminal configured to receive data from a source device. The terminal includes a terminal identifier, an input/output module configured to receive a code section lookup table from a source device, in which the code section lookup table contains a correlation between specific terminal labels and specific code sections, a controller configured to determine whether the terminal identifier of the terminal matches a terminal label listed in the code section lookup table, and to identify the specific code section corresponding to the matching terminal label in response to a determination that the terminal identifier of the terminal matches the terminal label, and a downloading module configured to download the matching specific code section from the source device.

Further disclosed is a computer readable storage medium on which is embedded one or more computer programs implementing the above-disclosed method of receiving data from a source device in a terminal having a terminal identifier.

### BRIEF DESCRIPTION OF THE DRAWINGS

Features of the present invention will become apparent to those skilled in the art from the following description with reference to the figures, in which:

FIG. 1 illustrates a simplified block diagram of a system for communicating data from a source device to a terminal, according to an embodiment of the invention;

FIG. 2 illustrates an example of a code section lookup table that is communicated from the source device to the terminal depicted in FIG. 1, according to an embodiment of the invention;

FIG. 3 illustrates a flow diagram of a method for communicating data from a source device to a terminal, according to an embodiment of the invention; and

FIG. 4 shows a block diagram of a computer system configured to implement or execute one or more of the processes depicted in FIG. 3, according to an embodiment of the invention.

### DETAILED DESCRIPTION

For simplicity and illustrative purposes, the present invention is described by referring mainly to exemplary embodiments thereof. In the following description, numerous specific details are set forth to provide a thorough understanding of the present invention. However, it will be apparent to one of ordinary skill in the art that the present invention may be practiced without limitation to these specific details. In other instances, well known methods and structures have not been described in detail to avoid unnecessarily obscuring the present invention.

Disclosed herein are a terminal and a method for downloading data from a source device to the terminal. The data includes, for instance, specific code sections targeted to the hardware platform of the terminal, which may be communicated to upgrade the hardware platform. Through implementation of the terminal and method disclosed herein, the complexity of the MSO head ends and the amount of bandwidth required to concurrently upgrade multiple hardware platforms are substantially reduced as compared with conventional systems and methods.

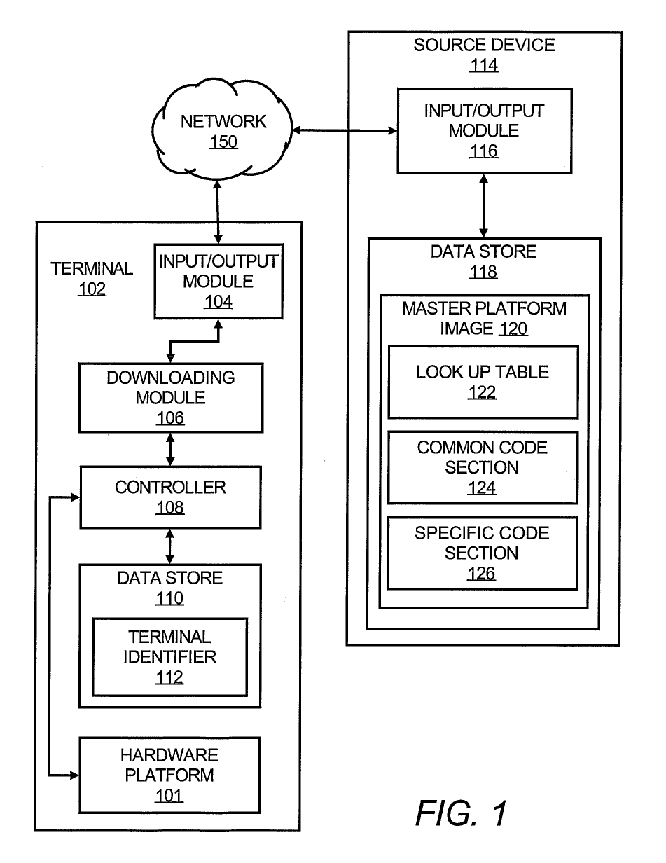

With reference first to FIG. 1, there is illustrated a simplified block diagram of a system 100 for communicating data from a source device to a terminal, according to an embodiment of the invention. It should be understood that the system 100 depicted in FIG. 1 may include additional components and that some of the components described herein may be removed and/or modified without departing from a scope of the system 100.

As depicted in FIG. 1, the system 100 includes a terminal 102 and a source device 114. The terminal 102 may comprise a set top box for receiving and processing multimedia content, for example, television programming, provided by the cable or satellite television operator. As such, the terminal 102 includes a hardware platform 101 for performing the receiving and processing functions. As discussed above, the hardware platform of the terminal 102 may differ from the hardware platforms of other terminals. In addition, the source device 114 may comprise a head end of an MSO configured to communicate data that may be used in updating the hardware platforms of variously configured terminals.

In addition to the hardware platform 101, the terminal 102 is depicted as including an input/output module 104, a downloading module 106, a controller 108, a data store 110, and a terminal identifier 112. The modules 104-106 may comprise software modules, hardware modules, or a combination of software and hardware modules. Thus, in one embodiment, one or more of the modules 104-106 comprise circuit components. In another embodiment, one or more of the modules 104-106 comprise software code stored on a computer readable storage medium, which is executable by a processor.

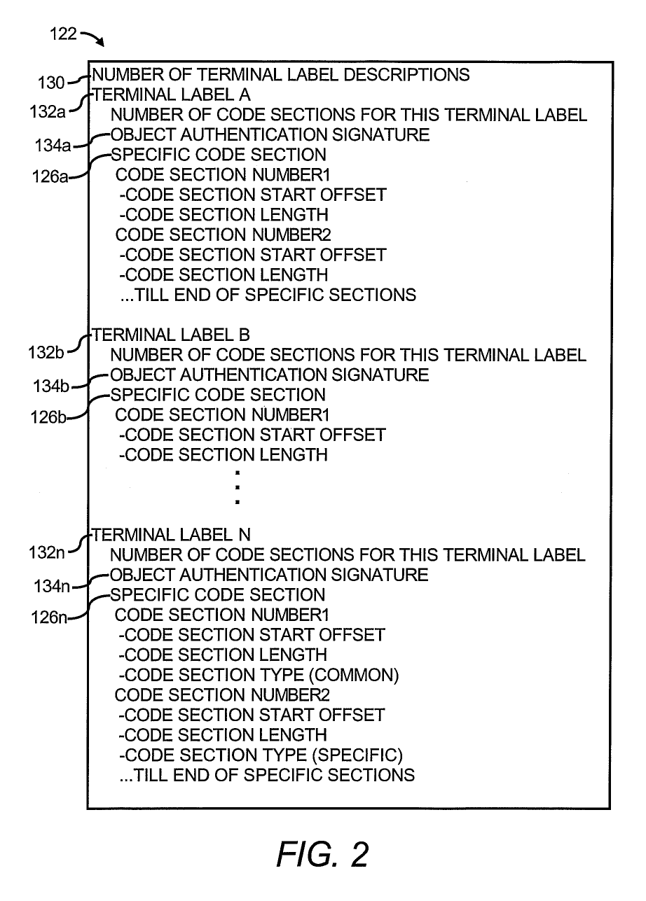

The terminal 102 is configured to communicate with the source device 114 through the input/output module 104. In particular, the input/output module 104 is operable to receive an instruction from the downloading module 106 to initiate a download of the code section lookup table 122 (FIG. 2) from the source device 114 to the terminal 102. Alternately, the input/output module 104 is operable to receive an instruction from the source input/output module 116 of the source device 114 to initiate the download of the code section lookup table 122 to the terminal 102. In any regard, the terminal 102 is configured to employ the code section look up table 122 in identifying one or more specific code sections that are targeted for the terminal 102, as described in greater detail herein below.

With reference to FIG. 2, there is shown an example of a code section lookup table 122 that is communicated from the source device 114 to the terminal 102. As shown therein, the code section lookup table 122 contains a total number of terminal labels 130 contained in the code section lookup table 122. In addition, the code section lookup table 122 lists each of a plurality of terminal labels 132a-132n and corresponding code sections from the plurality of specific code sections 126a-126n. For instance, for terminal label 132a, a specific code section 126a corresponding to the terminal label 132a is listed under the terminal label 132a. In addition, for each of the plurality of terminal labels 132a-132n, the code section lookup table 122 lists an authentication signature 134a-134n for the specific code sections 126a-126n corresponding to each of the plurality of terminal labels 132a-132n.

Turning back to FIG. 1, the controller 108 of the terminal 102 is configured to perform various functions in the terminal 102. In this regard, the controller 108 may comprise a microprocessor, a micro-controller, an application specific integrated circuit (ASIC), and the like, configured to perform various processing functions. In addition, or alternatively, the controller 108 may comprise software stored on a computer readable storage medium that may be executed by a computer processor. Some of the functions of the controller 108 include identification and authentication of the one or more specific code sections for the terminal 102 as described in greater detail herein below.

The terminal identifier 112 is a substantially unique character or collection of characters, for example alphanumeric characters, configured to distinguish the hardware platform 101 from hardware platforms of differently configured terminals and/or software contained in the terminal 102 from other software. The terminal identifier 112 may have been assigned to the terminal 102 based upon, for instance, the date on which the hardware platform 101 was assembled, the brand and product line of the terminal 102, the MSO from which the terminal 102 is programmed to receive multimedia content, the latest software update, etc. As shown in FIG. 1, the terminal identifier 112 is stored in the data store 110, which may comprise a combination of volatile and non-volatile memory, such as DRAM, EEPROM, MRAM, flash memory, and the like. In addition, or alternatively, the data store 110 may comprise a device configured to read from and write to a removable media, such as, a floppy disk, a CD-ROM, a DVD-ROM, or other optical or magnetic media. In addition, or alternatively, the terminal identifier 112 may be stored in a hardware component of the terminal 102. As a further alternative, the terminal identifier 112 is derived from terminal information of the hardware components and/or software stored in the terminal 102.

The controller 108 is configured to implement or execute the downloading module 106 to search the code section lookup table 122 to determine whether the terminal identifier 112 matches one of the plurality of terminal labels 132a-132n listed in the code section lookup table 122. Upon locating a matching terminal label, for instance terminal label 132a in the code section lookup table 122, the controller 108 is configured to implement or execute the downloading module 106 to download the specific code section 126a associated with the matching terminal label 132a from the source device 114 to the terminal 102. In addition, the downloading module 106 may be configured to download a common code section 124, which comprises code that is common to multiple hardware platforms. It should be understood that each code section may comprise a single code section, or alternately, a plurality of code sections as shown in FIG. 2.

As also shown in FIG. 1, the source device 114 includes a source input/output module 116 and a source data store 118. The source input/output module 116 may comprise a software module, a hardware module, or a combination of software and hardware modules. The source data store 118 may comprise a combination of volatile and non-volatile memory, such as DRAM, EEPROM, MRAM, flash memory, and the like. In addition, or alternatively, the source data store 118 may comprise a device configured to read from and write to a removable media, such as, a floppy disk, a CD-ROM, a DVD-ROM, or other optical or magnetic media.

In any regard, a master terminal image 120, which aggregates the code sections that may be communicated to a plurality of terminals, may be stored on the source data store 118. The master terminal image 120 includes the code section lookup table 122, the common code section 124, and the plurality of specific code sections 126. The common code section 124 may comprise one or more code sections that are applicable to some or all of the hardware platforms supported by the source device 114.

The source device 114 is operable to communicate with each of a plurality of terminals (only a single terminal 102 is depicted) through the source input/output module 116. In addition, the source device 114 may be configured to communicate with each of the plurality of terminals over a network 150. The network 150 may comprise, for instance, the Internet, a dedicated communications link from the source device 114 to the terminals, a satellite broadcast, etc.

As discussed above, some or all of the plurality of terminals may comprise different hardware platforms or alternately, substantially similar hardware platforms with different software configurations. As such, for instance, some or all of the terminals may require different specific code sections 126a-126n based upon the hardware platform and/or software contained in each of the terminals. Thus, for instance, the source device 114 may communicate substantially only those specific code sections 126a-126n that are required by each of the terminals and thereby substantially minimize the amount of bandwidth required to communicate the specific code sections 126a-126n to the plurality of terminals.

The source device 114 may initiate the transfer of the code section lookup table 122 to the terminal 102. Alternately, the source device 102 may receive an instruction from the terminal 102 to initiate the transfer of the code section lookup table 122 to the terminal 102.

According to an embodiment, the terminal identifier 112 comprises a hardware identifier, which identifies each supported configuration of the terminal 102 among the plurality of terminals that may be supported by the source device 114. A separate hardware identifier may be included in the code section lookup table 122 for each hardware variation of the same product line produced by the same manufacturer. Where a particular terminal identifier 132a-132n listed in the code section lookup table 122 is a hardware identifier, the specific code section 126a-126n associated with the hardware identifier is a hardware code section. Additionally, the common code section 124 may be a code section that is common across multiple ones of the hardware configurations among the plurality of terminals that may be supported by the source device 114.

According to another embodiment, the terminal identifier 112 comprises a model identifier, which identifies each supported model from each manufacturer among the plurality of terminals that may be supported by the source device 114. Where a particular terminal identifier 132a-132n listed in the code section lookup table 122 is a model identifier, the specific code section 126a-126n associated with the model identifier is a model code section. The model identifier may be burned into, for instance, a hardware component of the terminal 102 to identify the particular model type for the terminal 102. Alternately, the model identifier may be stored in the data store 110. Additionally, the common code section 124 may comprise a code section that is common across all model configurations for the same manufacturer.

By including the model identifier in the terminal 102, the system 100 enables the selective download of a code section selected from the specific code sections 126a-126n to support model types with different features. For example, a particular model type may have an Ethernet port while another model type from the same manufacturer may not have an Ethernet port. The model type with the Ethernet port requires a Transmission Control Protocol/Internet Protocol (TCP/IP) Stack and an associated Ethernet driver code section to support the Ethernet port while the other terminal does not require the code section selected from the specific code sections 126a-126n. By avoiding the download of code sections targeted towards features absent in particular model types, the system 100 reduces the amount of bandwidth used in communicating the code sections to the terminals.

According to an embodiment, the code section lookup table 122 is configured to provide a middleware configuration, such as, an OpenCable Application Platform (OCAP) middleware, on top of different hardware manufacturer implemented code for multiple different terminals. In this embodiment, the common code section 124 comprises the OCAP middleware.

According to a further embodiment, the terminal identifier 102 is a software feature identifier, which identifies each software feature that requires a code section selected from the specific code sections 126a-126n. Where a particular terminal identifier 132a-1 32n listed in the code section lookup table 122 is a software feature identifier, the specific code section 126a-126n associated with the software feature identifier is a software feature code section. Additionally, the terminal 102 may be configured to communicate with an end user interface (not shown) operable to receive instructions from a user to select and download the specific code section 126a-126n, where the code section selected from the specific code sections 126a-126n is a selected software feature code section. Further, in instances where the end user selects and downloads the selected software feature code section to the terminal 102, the downloading module 106 may be configured to automatically download code sections required to support the selected software feature code section.

The software feature identifiers may be configured by the source device 114. For instance, the source device 114 may configure a particular software feature identifier based on the selected software feature code section. Alternately, the software feature identifiers may be configured by interaction with the end user though the end user interface. For instance, where the end user selects a particular combination of software features to be downloaded from the source device 114, for example, a pay-per view feature, MP3 streaming from a computer, a home network connectivity, etc., the terminal 102 may be configured to derive the appropriate software feature identifier for the selected software feature(s). The terminal 102 may then employ the software feature identifier to identify the selected software feature(s) from the code section look-up table. The terminal 102 may also identify one or more other software features that are required to support the selected software feature(s) and may download the selected software feature(s) and one or more depending software feature code sections required to support the one or more other software features.

By configuring the master platform image 120 with software feature code sections corresponding to specific software features, the system 100 may enable end users to selectively download specific software features from the source device 114. In a typical system used by MSOs to support software feature downloads to similar hardware platforms, the hardware platforms are required to download an object consisting of code sections to support software features that may not be desired by a particular end user. By reducing the specific code sections downloaded to particular hardware platforms, the system 100 decreases the amount of non-volatile memory used.

The controller 108 may implement or execute the downloading module 106 to authenticate the specific code section 126a-126n either before or after the specific software feature code section has been downloaded to the terminal 102. More particularly, for instance, the downloading module 106 may locate the authentication signature 134a-134n within the code section lookup table 122 corresponding to the specific code section and may use an RSA Key in order to authenticate the specific code section 126a-126n. The authentication signature 134a-134n may also be used each time the terminal 102 is rebooted to verify that the code section selected from the plurality of specific code sections 126a-126n has been loaded.

The downloading module 106 may use the authentication signature 134a-134n to prevent code rollback attacks, which may occur where an older version of a code section with a security flaw is loaded in the terminal 102. In order to prevent this code rollback attacks during the download of each code section, the downloading module 106 is configured to check that the current signing time associated the authentication signature 134a-134n is greater than or equal to the signing time of the authentication signature of the code section previously loaded in the terminal 102. If the signing time of the authentication signature 134a-134n is less than the signing time of the previous authentication signature, the downloading module 106 may reject the download of the specific code section 126a-126n associated with the authentication signature 134a-134n.

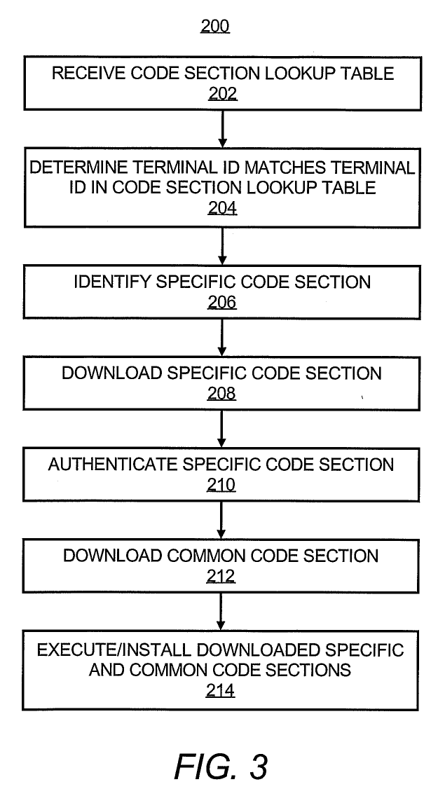

An example of a method in which the system 100 may be employed for receiving data from a source device 114 in a terminal 102 will now be described with respect to the following flow diagram of the method 200 depicted in FIG. 3. It should be apparent to those of ordinary skill in the art that the method 200 represents a generalized illustration and that other steps may be added or existing steps may be removed, modified or rearranged without departing from the scope of the method 200. Also, the method 200 is described with respect to the system 100 by way of example and not of limitation.

Some or all of the operations set forth in the method 200 may be contained as one or more computer programs stored in any desired computer readable storage medium and executed by a processor on a computer system. Exemplary computer readable storage media that may be used to store software operable to implement the present invention include, but are not limited to, computer system RAM, ROM, EPROM, EEPROM, hard disks, or other data storage devices.

At step 202, an input/output module 104 of the terminal 102 receives a code section lookup table 122 from the source device 114. In one embodiment, the downloading module 106 initiates the download of the code section lookup table 122 from the source device 114 by submitting a request for the code section lookup table 122 to the source device 114. In an alternate embodiment of step 202, the source device 114 initiates the download of the code section lookup table 122 to the terminal 102.

At step 204, the controller 108 implements or executes the downloading module 106 to search the code section lookup table 122 to determine whether the terminal identifier 112 matches one of the plurality of terminal identifiers 132a-132n listed in the code section lookup table 122. The search may be conducted through the relatively simple comparison of the terminal identifier 112 and the terminal identifiers 132a-132n listed in the code section lookup table 122. If the controller 108 determines that the terminal identifier 112 of the terminal 102 does not match any of the terminal identifiers 132a-132n listed in the code section lookup table 122, the controller 108 may end the method 200 and may discard the code section lookup table 122.

However, if the controller 108 determines that the terminal identifier 112 of the terminal 102 matches a terminal identifiers 132a-132n, at step 206, the downloading module 106 identifies the specific code section from among the plurality of specific code sections 126a-126n associated with the matching terminal identifier 132a.

At step 208, the downloading module 106 downloads the identified specific code section 126a.

At step 210, the controller 108 authenticates the downloaded specific code section 126a-126n. The controller 108 may authenticate the downloaded specific code section 126a-126n by locating the authentication signature 134a-134n within the code section lookup table 122 corresponding to the downloaded specific code section 126a-126n. Thus, for instance, the controller 108 may determine that the downloaded specific code section 126a-126n is authentic if the authentication signature of the downloaded specific code section 126a-126n matches the authentication signature 134a-134n of the downloaded specific code section 126a-126n contained in the code section lookup table 122. If the downloaded specific code section 126a-126n is not authenticated, for example a determination is made that the signing time for the downloaded authentication signature is less than the previous signing time, the selected software feature code section is rejected and may thus be discarded.

At step 212, the downloading module 106 also downloads the common code section 124 from the source device 114. Although not shown, the controller 108 may also authenticate the common code section 124 to substantially ensure that a previous version of the common code section 124 has not been received.

At step 214, the controller 108 executes and/or installs the downloaded specific and common code sections into the hardware platform 101 of the terminal 102. In addition, the controller 108 may store information pertaining to the executed/installed specific and common code sections such that the same specific and common code sections are not installed again at a later time.

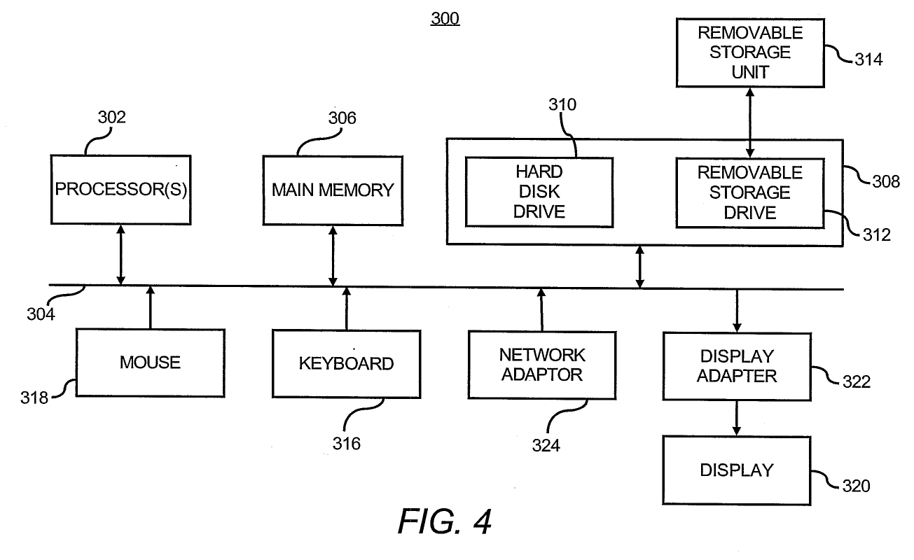

FIG. 4 illustrates a block diagram of a computing apparatus 300 configured to implement or execute one or more of the processes depicted in FIG. 3, according to an embodiment. It should be understood that the illustration of the computing apparatus 300 is a generalized illustration and that the computing apparatus 300 may include additional components and that some of the components described may be removed and/or modified without departing from a scope of the computing apparatus 300. The computing apparatus 300 may comprise the terminal 102 or the source device 114.

The computing apparatus 300 includes a processor 302 that may implement or execute some or all of the steps described in the method depicted in FIG. 3. Commands and data from the processor 302 are communicated over a communication bus 304. The computing apparatus 300 also includes a main memory 306, such as a random access memory (RAM), where the program code for the processor 302, may be executed during runtime, and a secondary memory 308. The secondary memory 308 includes, for example, one or more hard disk drives 310 and/or a removable storage drive 312, representing a floppy diskette drive, a magnetic tape drive, a compact disk drive, etc., where a copy of the program code for one or more of the processes depicted in FIG. 3 may be stored.

The removable storage drive 310 reads from and/or writes to a removable storage unit 314 in a well-known manner. User input and output devices may include a keyboard 316, a mouse 318, and a display 320. A display adaptor 322 may interface with the communication bus 304 and the display 320 and may receive display data from the processor 302 and convert the display data into display commands for the display 320. In addition, the processor(s) 302 may communicate over a network, for instance, the Internet, LAN, etc., through a network adaptor 324.

It will be apparent to one of ordinary skill in the art that other known electronic components may be added or substituted in the computing apparatus 300. It should also be apparent that one or more of the components depicted in FIG. 4 may be optional (for instance, user input devices, secondary memory, etc.).

The terminal and method disclosed herein enables an MSO to avoid requiring a different code section targeted to each hardware variation. Consequently, the object management responsibilities for the MSO head end are reduced and the loading of unnecessary code sections in hardware platforms is eliminated. Additionally, the terminal and method disclosed herein allow selective downloading of specific software features by customers. Further, the terminal and method disclosed herein allow the terminal to authenticate executable code sections, thus allowing, for instance, compliance with Open Cable standards.

Although described specifically throughout the entirety of the instant disclosure, representative embodiments of the present invention have utility over a wide range of applications, and the above discussion is not intended and should not be construed to be limiting, but is offered as an illustrative discussion of aspects of the invention.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, wherein the invention is intended to be defined by the following claims—and their equivalents—in which all terms are mean in their broadest reasonable sense unless otherwise indicated.

What is claimed is:

1. A method for receiving data from a source device in a terminal having a terminal identifier, the method comprising:
receiving a code section lookup table from the source device, said code section lookup table containing a correlation between terminal labels and specific code sections;
determining whether the terminal identifier of the terminal matches a terminal label listed in the code section lookup table;
in response to a determination that the terminal identifier matches a terminal label, identifying the specific code section corresponding to the matching terminal label; and
downloading the matching specific code section from the source device.

2. The method of claim 1, wherein the matching specific code section comprises an authentication signature and wherein the code section lookup table contains a correlation between specific code sections and authentication signatures, said method further comprising:
determining whether the authentication signature of the downloaded matching specific code section matches the authentication signature correlated to the downloaded matching specific code section in the code section lookup table; and
in response to a determination that the authentication signature of the downloaded matching specific code section matches the authentication signature correlated to the downloaded matching specific code section in the code section lookup table, authenticating the downloaded specific code section.

3. The method of claim 1, further comprising:
retrieving a previous signing time for a previous authentication signature associated with a previous specific code section, wherein the specific code section is downloaded to replace the previous specific code section;
obtaining a signing time for the downloaded specific code section; and
determining whether the signing time for the downloaded specific code section is greater than or equal to the previous signing time; and
in response to a determination that the signing time for the downloaded specific code section is greater than or equal to the previous signing time, authenticating the downloaded specific code section.

4. The method of claim 3, wherein authenticating the specific code section further comprises:
in response to a determination that the signing time for the downloaded specific code section is less than the previous signing time, rejecting the downloaded specific code section.

5. The method of claim 1, further comprising:
sending a request to the source device for the code section lookup table prior to the step of receiving the code section lookup table from the source device, wherein receiving the code section lookup table from the source device further comprises receiving the code section lookup table in response to sending the request.

6. The method of claim 1, wherein receiving the code section lookup table comprises receiving the code section lookup table from an operation initiated by the source device.

7. The method of claim 1, further comprising:
receiving a common code section from the source device, wherein the common code section is applicable to multiple terminal types.

8. The method of claim 7, wherein receiving the common code section comprises receiving middleware configuration and wherein downloading the matching specific code section further comprises downloading a manufacturer specific code section.

9. The method of claim 1, further comprising:
at least one of executing and installing the downloaded specification code section and the downloaded common code section.

10. The method of claim 1, wherein the terminal identifier comprises a software feature identifier and wherein the specific code section comprises a specific software feature code section.

11. The method of claim 10, further comprising:
receiving instructions through an end user interface connected to the terminal to select and download the specific software feature code section from the source device using the code section lookup table.

12. The method of claim 11, further comprising:
identifying one or more depending software feature code sections required to support the specific software feature code section and downloading the one or more depending software feature code sections.

13. The method of claim 1, wherein the terminal identifier comprises one of a model identifier and a hardware identifier and wherein the specific code section comprises one of a specific model code section and a specific hardware code section.

14. A terminal configured to receive data from a source device, said terminal comprising:
a terminal identifier;
an input/output module configured to receive a code section lookup table from a source device, said code section lookup table containing a correlation between specific terminal labels and specific code sections;
a controller configured to determine whether the terminal identifier of the terminal matches a terminal label listed in the code section lookup table, and to identify the specific code section corresponding to the matching terminal label in response to a determination that the terminal identifier of the terminal matches the terminal label; and
a downloading module configured to download the matching specific code section from the source device.

15. The terminal of claim 14, wherein the controller is further configured to at least one of execute and install the downloaded specification code section.

16. The terminal of claim 14, wherein the input/output module is further configured to send a request to the source device for the code section lookup table prior to receiving the code section lookup table from the source device.

17. The terminal of claim 14, wherein the matching specific code section comprises an authentication signature and wherein the code section lookup table contains a correlation between specific code sections and authentication signatures, wherein the controller is further configured to determine whether the authentication signature of the downloaded matching specific code section matches the authentication signature correlated to the downloaded matching specific code section in the code section lookup table, and to authenticate the downloaded specific code section in response to a determination that the authentication signature of the downloaded matching specific code section matches the authentication signature correlated to the downloaded matching specific code section in the code section lookup table.

18. The terminal of claim 14, wherein the controller is further configured to retrieve a previous signing time for a previous authentication signature associated with a previous specific code section, wherein the specific code section is downloaded to replace the previous specific code section, to obtain a signing time for the downloaded specific code section, to determine whether the signing time for the downloaded specific code section is greater than or equal to the previous signing time, and to authenticate the downloaded specific code section in response to a determination that the signing time for the downloaded specific code section is greater than or equal to the previous signing time.

19. The terminal of claim 18, wherein the controller is further configured to reject the downloaded specific code section in response to a determination that the signing time for the downloaded specific code section is less than the previous signing time.

20. A computer readable storage medium storing at least one computer program that when executed performs a method for receiving data from a source device in a terminal having a terminal identifier, the method comprising:
receiving a code section lookup table from the source device, said code section lookup table containing a correlation between terminal labels and specific code sections;
determining whether the terminal identifier of the terminal matches a terminal label listed in the code section lookup table;
in response to a determination that the terminal identifier matches a terminal label, identifying the specific code section corresponding to the matching terminal label; and
downloading the matching specific code section from the source device.
